(19) United States
(12) Patent Application Publication
(10) Pub. No.: US 2003/0122706 A1
(43) Pub. Date: Jul. 3, 2003

(54) Hybrid method and system of the improved bidirectional gps and cellular/pcs

(76) Inventors: Hee Youn Choi, Seoul (KR); David S Jun, Portland, OR (US); Peter Jun, Tualatin, OR (US); William Jun, Tualatin, OR (US)

Correspondence Address: Anderson Kill & Olick, 1251 Avenue of the Americas, New York, NY, 10020, US

(21) Appl. No.: 10/049,465

(22) PCT Filed: Mar. 8, 2001
(86) PCT No.: PCT/KR01/00388

(51) Int. Cl. G01S 5/14

(52) U.S. Cl. 342/357.1

(57) ABSTRACT

The purpose of the invention is to maximize and to optimize an intelligent and multipurpose functions for network by using a hybrid method, supplementing a re-transmission function, of improved bidirectional GPS (Global Positioning System) with the existing Cellular/PCS (Personal Communications Services). The invention, a hybrid method of combining Cellular/PCS and improved bidirectional GPS, manipulates as follows: GPS signals can be used independently, received from a Receiver (1) through a GPS (2) by using data stored on EEPROM (Electrically Erasable Programmable Read Only Memory) (4) via a Signal Hybrid Processor (3); an External I/O Interface (8) can retransmit time marked, status and operations and Function Manager (5) can also re-transmit various states of the PCS (Event Marking) as well as coordinate signals connected to Cellular/PCS network; Coordinates of User (a) are transferred Transmitter (1) and Antenna (A) and can call to user (b) simultaneously; In this case, coordinates of User (a) are converted to ASCII codes in DB (Data Base) of station, and display into User (b) with Use (a) ID (Identification) and real locations like address (street name and so on), such a way that shows as following. Receiver (B)→RF (Radio Frequency)/IF >(Intermediate Frequency) (C)→Baseband Processor (D)→Display Device (7). This Hybrid Method implements a data base from t acquired data on network for various intelligent functions.

### BACKGROUND OF THE INVENTION

1. Field of the Invention

The invention is based on a hybrid method of supplementing an improved bidirectional GPS functions with an existing Cellular/User PCS system and of retransmitting coordinates of user and status of I/O (Input/Output) devices into the station. It can be an implemented various intelligent mobile networks in the following fields.

1) User Applications (When User Carries the Cellular/PCS)

(1) Locating identification on real time

(2) Tracking against abduction and Tracing criminal alibi

(3) Logging by the DB Implement on the network

(4) User's movement patterns classified by days, weeks, and seasons

(5) User's remote navigation

2) Vehicles and Transportation (Compulsory Placement of the Cellular/PCS in Vehicle)

(1) Real-time location of identification for a specific vehicle

(2) Identification for distribution on time and vehicle class by the DB Implement on the network

(3) Identification for over-speeding vehicles

(4) Black box function at car accident

(5) Identification for movement and speed pattern of specific vehicle by the DB Implement

(6) Recovery of stolen vehicles

3) Automatic Post-Payment (Without Extra Local Sensors)

(1) Automatic post-payment for toll gate fees

(2) Automatic post-payment for parking fees

(3) Automatic post-payment for admission fees of recreational parks

(4) Automatic post-payment for admission fees for theaters and stadiums

4) Identification for Exit and Entrance

(1) Automatic identification of the office-going hour

(2) Automatic control of restricted area and identification of trespassing

(3) Automatic identification for trespassing numbers of people

(4) Utilization as an entrance electrical key

5) Utilization for Medical Fields (By Attaching I/O Interface to Cellular/PCS)

(1) 24 hours real-time monitoring on an electrocardiogram, pulse rate, and brain waves of patients

(2) Monitoring of exercise load tests (Automatic reading of exercise speeds)

(3) Identification for life style of patients by the DB Implement

6) Utilization for Security Inspection in Home and Office (By Attaching I/0 Interface to Cellular/PCS)

(1)Real-tine identification of exact locations by attaching I/O sensor, impact sensor and contact sensor to I/O Interface.

(2) Automatic identification at window and entrance by installing Cellular/PCS

(3) Easy utilization in vehicle and during vacation

7) Utilization in the Field of Home and Office Automation (By Attaching I/O Interface to Cellular/PCS)

(1) Automatic on and off for an electric light at home and in the office through Cellular/PCS

(2) 24 hours monitoring of temperature and humidity at home and in office

(3) Remote on and off control for home appliances and equipments

(4) Remote on-off control of electrical and electronic devices in the office

(5) 24 hours monitoring of operational status for home/office electrical devices and temperature and humidity

8) Utilization for Factory Automation and Monitoring (By Attaching Cellular/PCS to I/O Interface)

(1) Remote control of the devices needed to be controlled, frequently moving, in the factory

(2) Utilization on locations needed to be monitored, frequently moving, in the factory

9) Utilization on Automatic Measurement in the Industrial Applications

(1) Automatic measurement and monitoring of the rainfall

(2) Automatic measurement and monitoring of flood gate (lock) and water level

(3) Automatic measurement and monitoring of internal combustion

(4) Automatic measurement and monitoring of noise

10) Utilization as ID Cards and Credit Cards (Substitution to User ID Card by Improved Cellular/PCS)

(1) Substituting an existing ID card by expanded distribution of minimized and improved Cellular/PCS

(2) Easy and safe to carry

### DESCRIPTION OF THE RELATED ART

The conventional Cellular/User PCS has been developed and improved in several types of technologies; at early stage, the AMPS of an analog mode was developed, based on FDMA technology. Afterwards, various digital modes were developed, based on FDMA technology. As the network of GSM series, GSM900, GSM800, GSM1900, DCS (Distributed Control System)1800, PCS1900 and PDC (Pulse Duration Code) as technologies of TDMA mode have been used. The CDMA mode as same digital mode has also used. FIG. 1a shows a structure for analog mode of AMPS, based on conventional TDMA and digital mode, CDMA. FIG. 1b shows an existing GSM mode, based on TDMA.

All standard modes, which have been developed today in FIG. 1a and FIG. 1b, have been used only for mutual exchange of sound and character information. In partial GSM transformation technology, there exists location-identification function (GPS in narrow meaning) by carrier signal to identify the location of user in a cell on network. This function is to identify the location of the cell where user exists through the process by Receiver, RF/IF, and Base Band of Cellular/PCS on the signal discharged from the base station of each cell. But, this is not the function to identify the location of real coordinates. In other words, the base station on a network as well as user itself cannot locate real coordinates of Cellular/PCS users. Therefore, it might be impossible to locate Cellular/PCS users and to make various intelligent applications by existing modes developed up to date. Besides, as shown in FIG. 2, the existing devices of unidirectional GPS itself is too limited since they receive signals in same direction and recognize coordinates independently. It simply recognizes only the location of user itself. This invention has various effects of applications on a network because it transmits the recognized locations of users through the Cellular/PCS communications as well as user identifications, the location of user itself.

There is another existing technology to identify the location of users. It is the most recent standard mode regulating to identify the user's location in emergency. The existing technology increases the output intentionally in the user terminal in emergencies more than in ordinary times. The increased output signal reaches other adjacent stations out of the station in a cell user location. Theoretically, the transmitted user's location can be recognized when the user arrives in more than three adjacent stations. However, this existing technology has three disadvantages. First, when the frequency for emergency increases, the quality of communication gets worse as a whole because the output of the user terminal is controlled to minimize states in order not to go over to other stations, regardless of the type of Cellular/PCS communication. The numbers of simultaneous users are highly limited and the best quality cannot be kept when the signal reaches other adjacent stations out of its own station. Second, the accuracy to identify the user's location is decreased because there is limitation in sending enough output signals for the user of the terminal to reach more than three stations intentionally. In addition, on probability is the invention more accurate and more reliable than the existing technology since this invention identifies the location on real-time basis only in the station the user belongs to. Finally, existing technologies are impossible to identify the real-time locations, but they are used limitedly in emergency. Thus, the invention has various effects of applications on the network.

### SUMMARY OF THE INVENTION

The purpose of this invention is to solve problems of location recognition of an existing Cellular/PCS terminals and to have several effects of applications on the network, which does not supported by existing technology, by combining and implementing a simple location identification function of existing unidirectional GPS to Cellular/PCS with bidirectional communications.

The invention is to maximize the function of intelligent multipurpose network functions with an existing Cellular/User PCS by identifying the coordinates in GPS and by adding the retransmit function. This invention also is to maximize the function of intelligent multipurpose network functions by marking various events (emergency, count), and at the same time, to control the inputs/outputs of various devices. Maximization of the function of intelligent multipurpose network means pre-described various advantages in the industrial fields.

For better understanding, the existing Cellular/PCS device is presented with lined block in lower part of FIG. 3 and the circuit elements in the block are arranged in an alphabetical order [For example, Antenna (A), Receiver (B), and so on]. Moreover, the GPS device with an added retransmitting function is presented with dotted-line block in upper part of FIG. 3., and the circuit elements in a block is presented in the bracketed numbering (for example, Receiver (1), GPS (2), and so on).

As shown in FIG. 3, the signal from an conventional active Antenna (A) is transferred to Receiver (B) for a basic function of conventional Cellular/PCS. At the same time, the signal from Antenna (A) is transferred to Receiver (1) for identification of exact coordinates. The signal from GPS Receiver (1) goes through GPS (2), and becomes the input to Signal Hybrid/Processor (3). In Signal Hybrid/Processor (3), current date and time is inserted and the various signals are produced through the Functional Manager (5). The Signal HIybrid/Processor (3) inputs and outputs processing data to the storage device of the EEPROM (4). The Function Manager (5) inputs and outputs signals through Audio/Control & Interface (F). In addition, the Function Manager (5) sends and receives signals of the External I/O Interface (S), and transfers them to the Signal Hybrid/Processor (3). The External I/O Interface (8) as a selection device inputs and outputs through A (Analog)/D (Digital), D/A, or direct converter for an analog signal process. The digital signals are fed through digital I/O into the I/O interface (8). All the signals processed at Signal Hybrid/Processor (3) are transmitted through the existing Baseband/Processor (D) of Cellular/PCS. At the Baseband Processor (D), all the transferred, GPS-related data from a basic function of conventional Cellular/PCS and the Signal Combination Processor (3) are transferred to the RF/IF (C). At RF/IF (C), transferred signals and information are retransmitted through the Transmitter (I) and Antenna (A). The GPS obtains bidirectional functionality by transmitting real coordinates from the GPS through complex hybridized Cellular/PCS. Both improved transmittable bidirectional GPS and conventional Cellular/PCS are hybridized because they use a common antenna, and they send and receive signals through the Baseband Processor (D) and Signal Hybrid/Processor (3), and then the Audio/Control & Interface (f) and the Function Manager exchange signals with each other.

In FIG. 3, the Receiver (1) receives signals only for determining coordinates from individual satellite for GPS, different from the waves sent from existing Cellular/PCS communication. The Receiver (B) receives waves only, sent for existing Cellular/PCS communication. Receiver (1) and Receiver (B) have totally different frequency bands and convert functions. The converted signals through GPS Receiver (1) become inputs to GPS (2) and outputs of GPS (2) are converted into real coordinates of user's location, and then are fed into the Signal Hybrid/Processor (3). At Signal Hybrid/Processor (3), all the signals and real output coordinates of the user are processed and transmitted to existing Cellular/PCS through the Baseband Processor (D). In other words, the acquired time of data are marked through the Signal Hybrid/Processor (3). In date and time of marking, real coordinates in exact time are acquired and are loaded on the EEPROM (4) in a timely order through the Signal Hybrid/Processor (3). The reason why date and time are stored on the EEPROM (4) is that the processing times, taken in transferring them to the station or other users, is different even though acquired coordinates are transmitted on real time basis. It might not be possible to determine the time when the user's coordinates were acquired, in case where the time is counted at the station, other user's terminal or database. Especially, when the coordinates were acquired at storage mode instead of real time mode, the marking date and time acquired are necessary. It is necessary for acquired coordinates and tine to be stored and processed in the database for further application described later. The acquired coordinates and marked date and time are saved at the EEPROM (4) and transferred through the Signal Hybrid/Processor (3), and the existing Cellular/PCS Baseband Processor (D) by the direction of Functional Manager (5).

Next, the acquired coordinates and marked date and time through the path of Baseband Processor (D)→RF/IF (C)→Transmitter (I)→Antenna (A) are generated together with the user ID, other user's calling number, and sound signal (that is, other user's called number, user ID, and sound signal) through the Baseband Processor by existing Audio/Control & Interface (F). In other words, other user's calling number, user ID, sound signal from existing Cellular/PCS are hybridized with acquired coordinates and time from improved bidirectional GPS, and then are transmitted through the antenna. In an existing communication mode which do not generate the user ID, it will be generated in added Function Manager (5). It is typically the simplest type of functions. The detailed time configurations are presented in FIG. 6. The FIG. 6. shows the modulation at sound communication exclusive mode. At the first half of header (header1), other user's calling number and the user 11) exist and at second half of header (header2), acquired Coordinates (C) from the added GPS and acquired Time (t) locate. Afterwards, sound or letter signals are modulated and transferred. FIG. 6b shows a modulation of acquired coordinates at transmission exclusive mode. The front part of the full header is identical to that in FIG. 6a, but is not identical at transferring of acquired coordinates and time instead of sound and letter signal. The transmission exclusive mode of acquired coordinates and time are to be scheduled at the Function Manager (5).

When the event is acquired through an existing keypad of Cellular/PCS and Sound Recognizer, it inputs and outputs in Function Manger (5) through Audio/Control & Interface (F), and the result is fed into the Signal Hybrid/Processor (3) by setting basic menu functions of Function Manager as shown in FIG. 5. At this time, the modulation is generated in a form of FIG. 6c or FIG. 6d through the Signal Hybrid/Processor (3) and Baseband Processor (D). This signal is modulated to communicable frequency through the RF/IF (C) and transmitted through Transmitter (1) and Antenna (A). By using the Signal Hybrid/Processor (3), in main menu functions of Function Manager as shown in FIG. 5, acquired event is stored at EEPROM (4) first, followed by [GPS FUNCTION]→[TRANSMIT MODE]→[STORAGE/TRANSMIT] or [STORAGE ONLY] set. An example of the detailed memory map, when stored at EEPROM (4), is shown in FIG. 7. In the basic menu of function Manager of FIG. 5, [GPS FUNCTION]→[TRANSMIT MODE]→[REAL TIME] mode is set . All values are determined, and the device address, status and data are set. It is modulated as shown in FIG. 6d., and transmitted through Signal Hybrid/Processor (3)→Baseband Processor (D)→RF/IF (C)→Transmitter (I)→Antenna (A). The detailed examples are illustrated.

When the data of I/O Device is transferred through the External I/O Interface (8), they are transmitted through the same path and are processed in a transformed form as shown in FIG. 6c or FIG. 6d, in case of basic menu function of Function Manager in FIG. 5 [I/O Interface Function]→[Specific I/O Device]→[Device Address] is set by the Function Manager (5). At this time, the difference from prescribed events is the mode and device address as shown in FIG. 6c and FIG. 6d. FIG. 4 shows possible combination modes in every case. It is classified into three classes as CASE (1), CASE (2). CASE (3), and mode is determined depending on setup of Event and I/O Device. In basic menu of Function Manager in FIG. 5, when [Display]→[Caller Location]→[Address] is set, coordinates of User (a) is transmitted through Transmitter (1) Antenna (A) and afterwards, User (a)'s coordinates is converted to ASCII in the database of the station when calling other User (b), and next it is marked to User (b) with User (a)'s ID and real location (street name) through Receiver (B)→RF/IF (C)→Baseband Processor (D)→Display Device (7).

Many types of Cellular/PCS modes developed up to date (for example, varisous FDMA-AMPS, TDMA-GSM series, TDMA-PDC series, or CDMA mode) are also generally identical to GPS Interface mode and Signal Hybrid mode as shown in FIG. 3.

FIG. 8 illustrates applied examples of implementing various database in case of addition of retransmit function after identification of GPS coordinates in existing Cellular and PCS mode. All coordinates, marked time, events and various I/O information transmitted by user can he transmitted to another user individually, but this can be maximized into effect by implementing the database. The database on the network manages all information of the user as a whole. In addition, it can provide hybrid data services opened on the network for specific purposes (for example vehicle control/management service, toll fee management services, user management services, remote medical diagnosis services, home/office automation/management services).

### BRIEF DESCRIPTION OF THE DRAWINGS

FIG. 1 shows a basic structure of existing AMPS (Advanced Mobile Phone Service) (FDMA (Frequency Division Multiple Access)), TDMA (Time Division Multiple Access), CDMA (Code Division Multiple Access), and GSM (Global System for Mobile Communications)

FIG. 2 shows a basic structure of conventional unidirectional GPS

FIG. 3 shows a hybrid method of improved bidirectional GPS/Interface and Cellular/PCS

FIG. 4 illustrates an example with detailed data combinations

FIG. 5 illustrates an example for basic menu functions of the Function Manager

FIG. 6 illustrates an example for modulations on communications

FIG. 7 illustrates an example for memory mapping of the EEPROM (4)

FIG. 8 illustrates an example of data base applications for the hybrid method and systems reinforcing GPS re-transmission function with existing Cellular/PCS user terminals

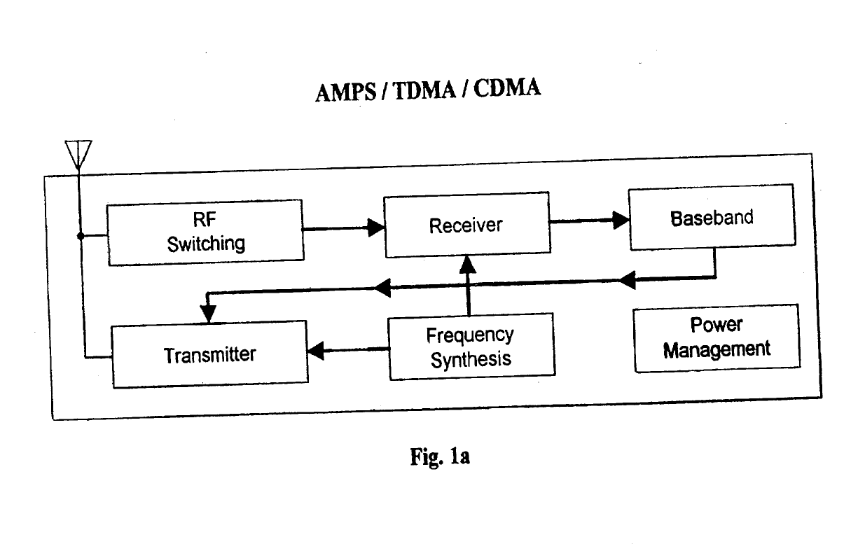

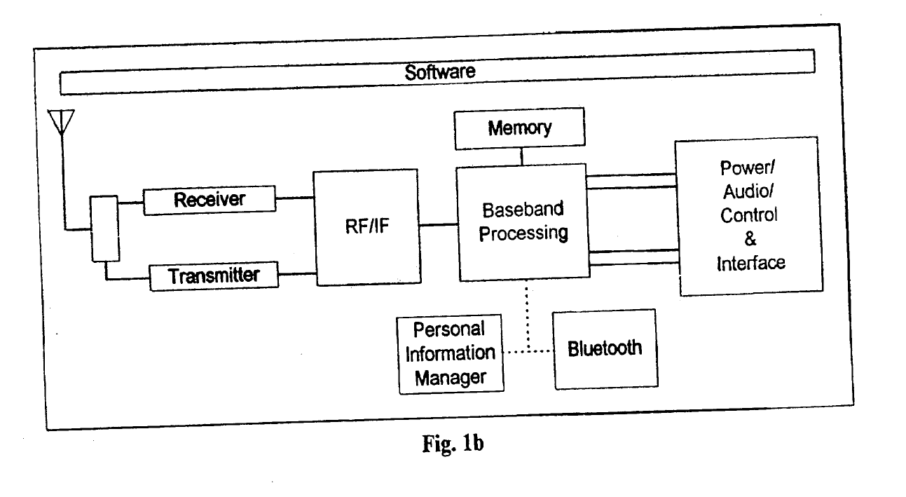

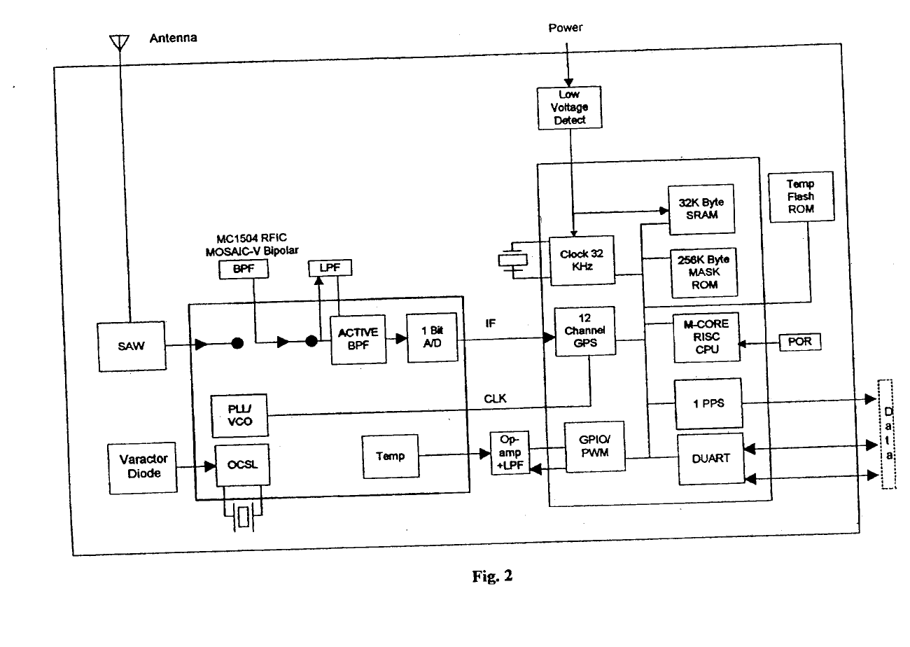

### DETAILED DESCRIPTION OF THE PREFERRED EMBODIMENTS

The structures and operations in the above sections will be described. Now, detailed examples in several cases will be described in detail.

<1>Example of User

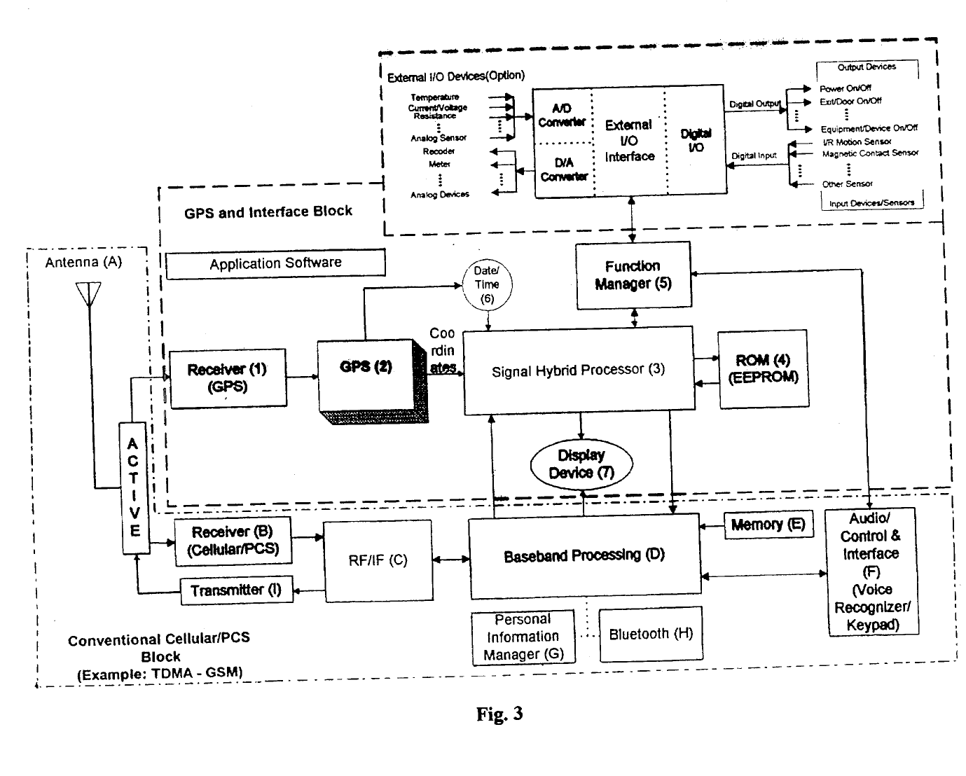

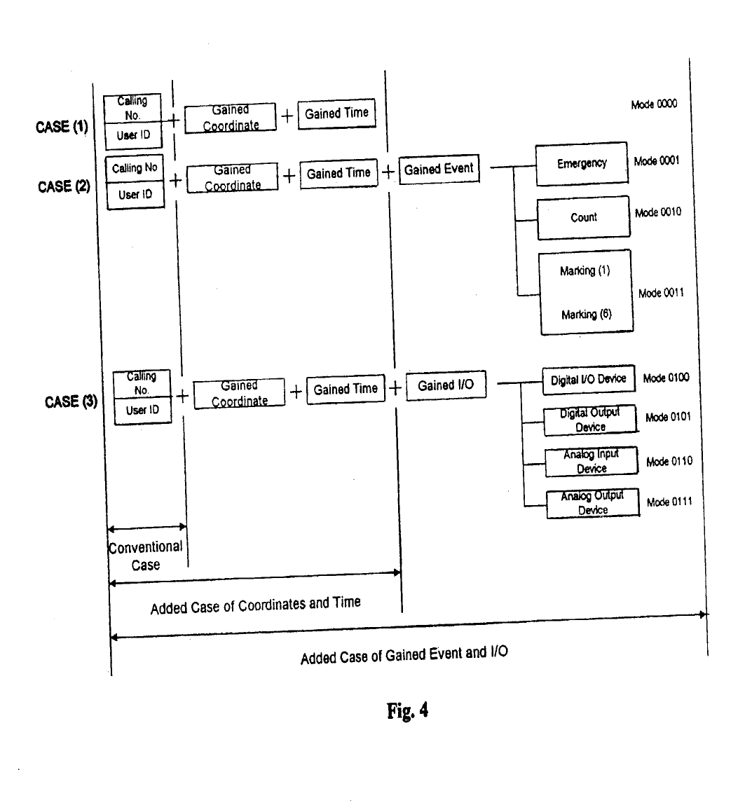

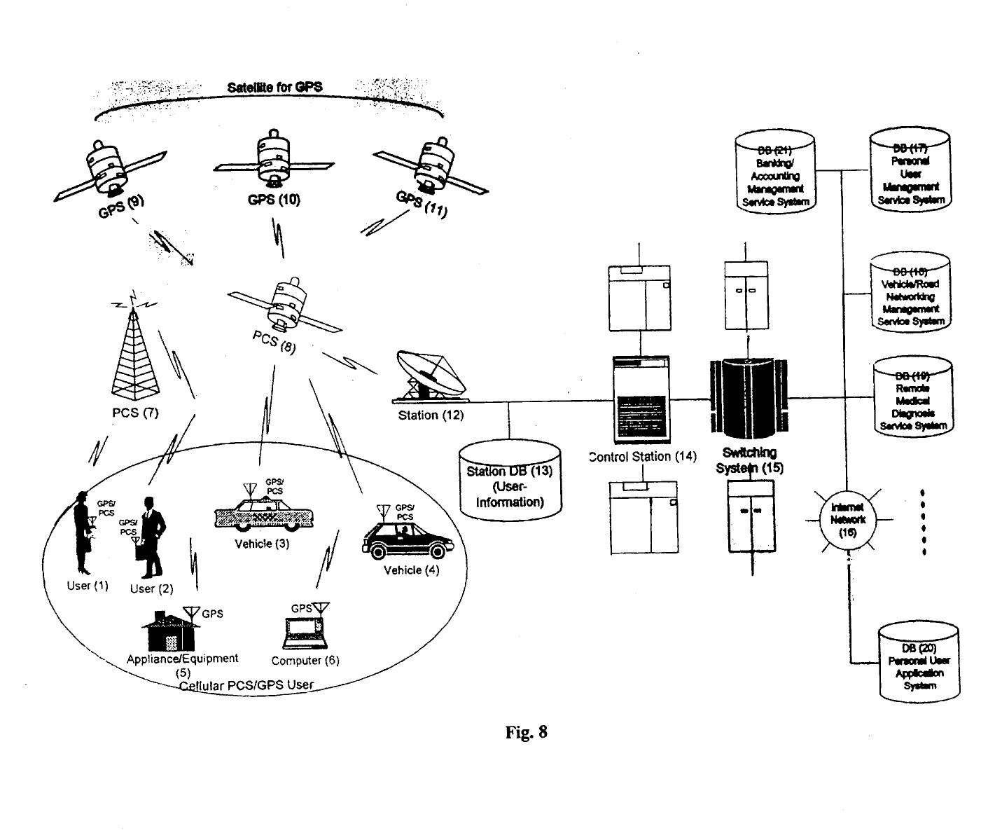

If Transmitter User (1) in FIG. 8 calls Receiver User (2), through Transmitter User (1) device→Antenna (A)→GPS (2) in FIG. 3 via coordinate satellite of GPS (9), GPS (10), GPS (11), the received real coordinate and marked date/time (6) signal will go through Signal Hybrid/Processor (3)→Baseband Processor (D), and user ID will be added at the user information manager and retransmitted through RF/IF, (C) Transmitter (1)→/Antenna (A).

User ID, marked date/time, and user coordinates reach Station (11) and Station DB (13) through PCS (7) or PCS (8) as shown in FIG. 8. At Station DB (13) in which all the user information is stored, all the information of Transmitter (1) is converted into letter information, and all the information including current location (street name) is marked through Station DB (13)→PCS (8) Receiver User (2)→Antenna (A) in FIG. 3→Receiver (B)→RF/IF (C)→Baseband Processor (D)→Display Device (7).

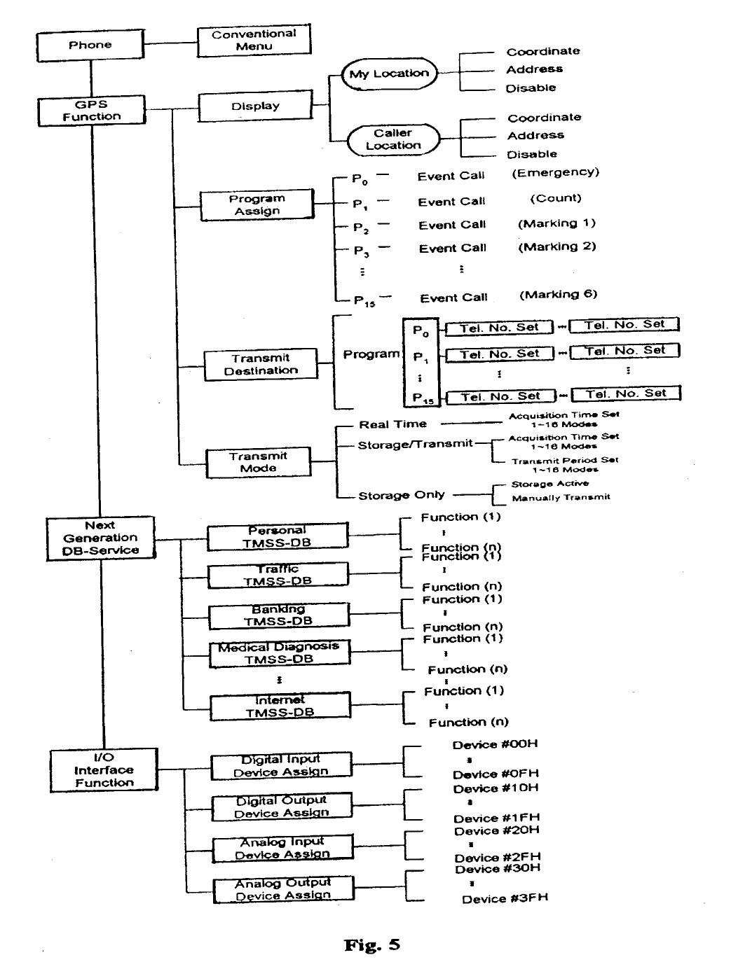

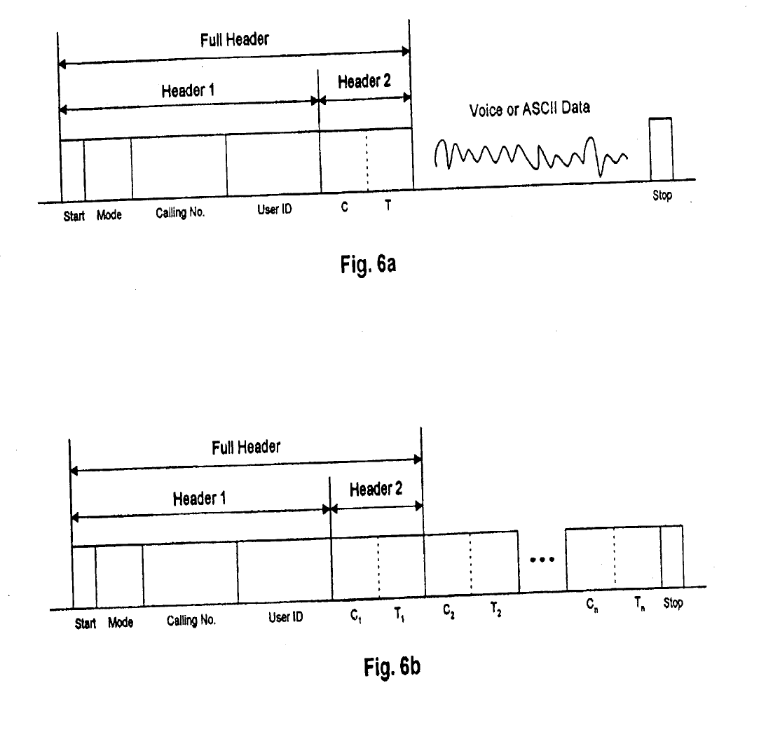

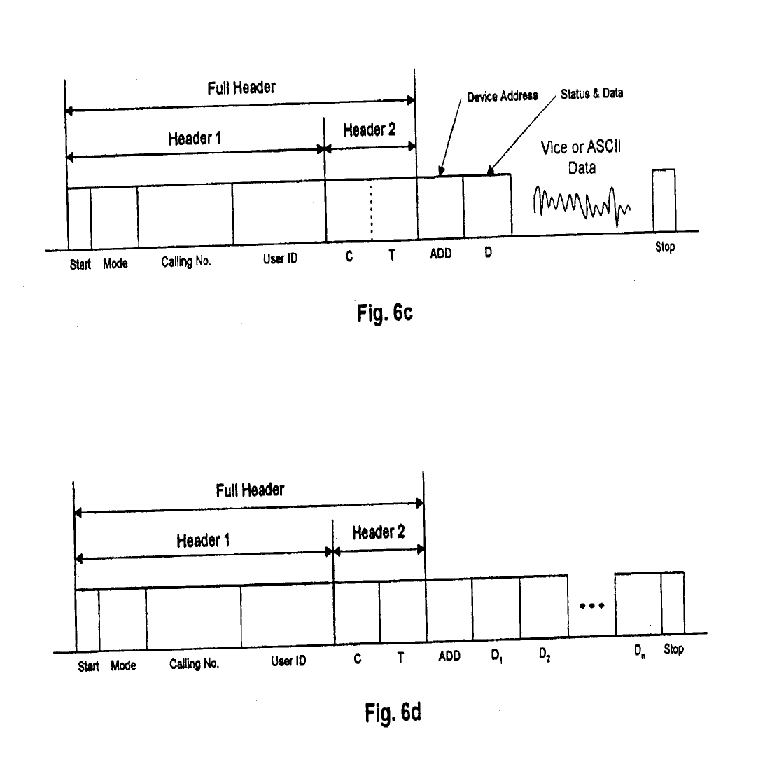

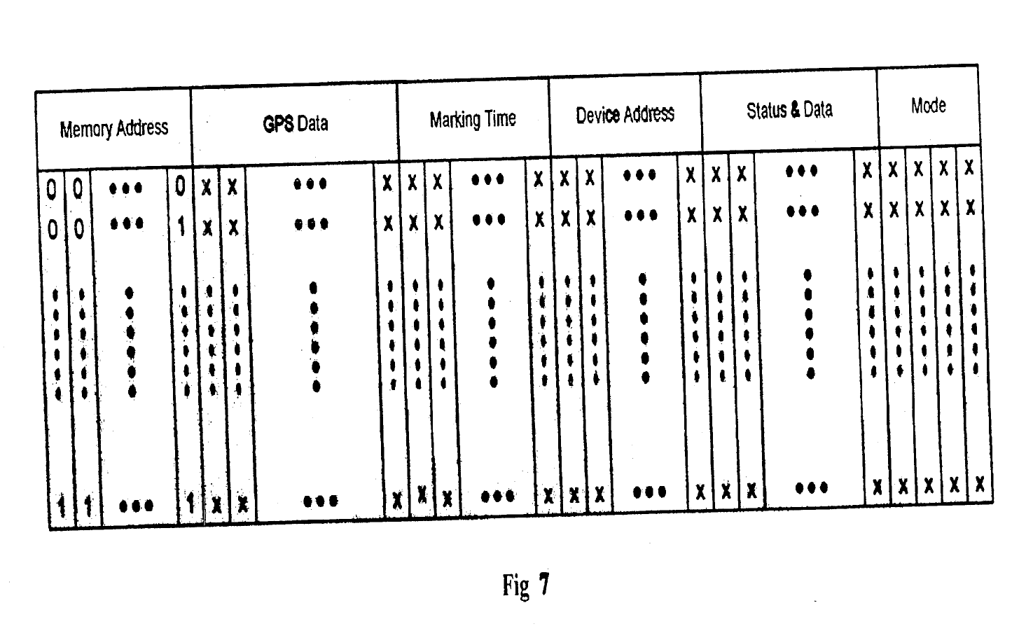

The configuration of the wave packet in time when transferred to the network is presented at the modulation of sound communication exclusive mode as shown in FIG. 6a. The whole header divides into the first half Header (1) and the second half Header (2). In the first half Header (1), start bit, the user ID, and mode for control are loaded. The mode is determined into concrete combination by a menu setup of the Function Manager in FIG. 5 through Function Manager (5)→Signal Hybrid/Processor (3)→Baseband Processor (D). The second Header loads marked real coordinates, time and letter information. After Header, the sound/letter information, or real-time coordinates are transmitted, depending on which node comes first.

Coordinates of Transmitter User (1) in FIG. 8 emits through Antenna (A)→GPS (2) and next are automatically recorded with Marked date/time (6) signal in where Transmitter User (1) stores the information on a his/her own device for his/her privacy and identifies his/her past record.

It explains the case of acquisition of event taken through existing keypad or sound recognizer. This is the case when the signal is inserted at the Function Manager (5) through Audio/Control & Interface (F) of Cellular/PCS, and again is stored at the EEPROM (4) through, Signal Hybrid/Processor (3) or retransmitted automatically to RD/IF (C)→Transmitter (I)→Antenna (A) through Baseband Processor (3). The acquired event here is memorized or transmitted at the same time together with prescribed and acquired coordinates and acquired time. For detailed examples, when recognized at keypad or sound recognizer in an emergency, acquired coordinate, acquired time, event code, user ID, other user's calling numbers are transmitted together. Other user's calling numbers are in an advanced set at the Function Manager (5), but are not memorized at the EEPROM (4) everytime they are acquired. The instance for count and special marking is the same as prescribed examples, hut is different in the event code. When Transmitter User (1) continuously, transmits his/her own's coordinates on real time, the information of Transmitter User (1) becomes Antenna (A)→Receiver (1), and GPS (2)→coordinates of User (1), and current time will be produced. According to selected items in [GPS Function]→[Transmit Model]→[Real Time] of the menu in FIG. 5. The signals and modes are marked through Function Manager (5)→Signal Hybrid/Processor (3), and are transmitted via Baseband Processor (D)→RF/IF (C)→Transmitter (1)→Antenna (A).

The transmitted signal is transferred to the user management service system through Transmitter User (1), PCS (7)/PCS (8), Station (12), Control (14), Switching System, and DB (17). The information of Transmitter User (1) received from the network with opened DB (17) is stored on real time and can provide various services, based on DB generated. User can utilize the DB (17) User total management system through the internet networks on the implemented network.

When the method of the invention is utilized in a network in FIG. 8, the real time location of a specific user, moving pattern of user by date, week, and season can be analyzed by the user total management service system. At abduction, the location can be identified by tracking, and it can be utilized for proof of alibi in criminal cases. On attending and leaving the office, it can be used for the exact management.

<2>Vehicle and Transportation

Coordinates of vehicle (3) in FIG. 3 are derived from Antenna (A) and GPS (2), and go with marked date/time signal through Signal Hybrid/Processor (3) and Baseband Processor (D), and User Information Manager (G) adds user ID, and then it is transmitted through RF/IF (C), Transmitter (I), and Antenna (A). User ID, marked date/time and user coordinates can be processed at Station DB (13) through PCS Satellite (S) and Station (12) in FIG. 8. When the user uses Cellular/PCS attached in vehicle, the real-time monitoring for specific vehicle and the classes of vehicle in road network and movement pattern by time can be obtained by using a DB on the network in FIG. 8. Besides, one can calculate speed at a specific location of a vehicle or an average velocity of it in a specific area by calculating variables of coordinates, according to time changes and it can figure out whether it is going over the speed limit. It can al low a remote administration vehicle black box function that reverses tracking status of moving forward and backward, and the speed of vehicle which was in an accident by using data stored in Vehicle/Road Network Management Service System (18) on the network as an example shown in FIG. 8. It is possible to find out and to get a stolen vehicle back by verifying the location of the vehicle bad using DB (18) on the network.

<3>An Instance of Automatic Toll Payment

When a vehicle (4) in FIG. 8 passes a toll gate or a parking spot whose location coordinates are already informed, the vehicle (4) passes through Signal Hybrid/Processor (3)→Baseband Processor (D) with real coordinates and marked Date/Time (6) Signals from the device of the passed vehicle (4) through Antenna (A)→GPS (2) in FIG. 3, and adds user ID in User Information Manager (G), and re-transmit through RF/IF (C)→Transmitter (I)→Antenna (A). User ID, marked date/time, and user coordinates are transferred to Station (12)→Control (14)→Switching System DB (18); Vehicle/Road Network Management Service System in sequence through PCS (7) or PCS (8) in FIG. 8. It can automatically pay later for pre-informed toll and parking on a network because coordinates and time of both directions are verified on the DB (18) opening.

<4>Instance of Substitutes for ID Card/Credit Card

Another advantage of using this invention is that it can be an substitute for current ID Card and Credit Card systems and make them more perfect by using Cellular/PCS with an added retransmit function of an improved bidirectional GPS if number of users increases and the size of the product gets smaller. It will be a more perfect ID card system when making it mandatory to attach current ID card by the law on a front panel GPS-Cellular/PCS, because you can make a perfect ID system which is hard to alter in neither time and space set in the new ID card system using this invention digital ID since user's coordinates and time are automatically recorded on real time basis as database on the network in addition to the photo in current ID card system. In case of loss or misuse by a person other than the original card holder, it transmits location information so that it can be restored quickly. It can be prevented from being used by others because all records appear at the DB on a network.

It will be a handy and secure next generation payment system by adding a retransmit function of improved bidirectional GPS of this invention to Cellular/PCS. This means that the seller and the buyer would not have to give and take the credit card as in the current credit card system. All transition information will be checked on real time basis on a network. It would be more secure payment system because on real time, log and user's location are recorded on the separate DB.

The process can be described as follows. A buyer User (1) in FIG. 8 chooses a system menu in FIG. 5 of General Banking/Accounting Management Service of next generation to pay on a network. Seller User (2) in FIG. 8 sets the menu from the device of the invention and asks on the network. If Seller User (2) has already opened a real time database on network, information on User (1) should already appear on the Display Device (7) through the network. It is why buyer User (1)'s ID, time, and coordinates information are transmitted to the seller User (2) through the network. At this point, seller User (2) just inputs prices through a keypad or voice. Now, seller User (2)'s ID, time, and price information appear on the display device of the buyer User (1), and then final payment request can be made. Buyer User (1) verifies the password by a keypad or voice recognizer, and then payment is made automatically on the network DB.

Next, an explanation will be made on all processes mentioned above in detail. First, the information of buyer User (1) outputs coordinates and current time of User (1) through Antenna (A)→Receiver (1)→GPS (2). If [Next Generation DB]→[Banking TMSS]→[Function]→<Payment Request>is selected, the signal will be marked via Function MAnager (5)→Signal Hybrid/Processor (3), and be transmitted through Baseband Processor (D)→RF/IF (C)→Transmitter (1)→Antenna (A). Transmitted signals are conveyed to Station (12)→Control (14)→Switching System DB (21): Banking/Accounting Management Service through user (1)→PCS (7) or PCS (8) in sequence as shown in FIG. 8. When DB (21) opens, it waits for Seller User (2) to propose payment, based on information of buyer User (1) that has been entered.

Paymant to seller user (2) made on the network outputs punched price through Audio/Control & Interface (F) with marked coordinates and time as well as through GPS (2) of seller User (2). If [Next Generation DB]→[Banking TMSS]→[Function]→<Collection Demand> is selected on the menu of FIG. 5, the signal is transferred to Function Manager (5)→Signal Hybrid/Processor (3) and is transmitted through Baseband Processor (D)→RF/IF (C)→Transmitter (I)→Antenna (A). The signal transmitted will be put on the Banking/Accounting Management Service System through Station (12)→Control (14)→Switching System→DB (21) via seller User (2) of FIG. 8→PCS (7) or PCS (8).

Information of buyer User (1) and seller User (2) are mutually verified in DB (21) (especially, figuring out location of one another), and are requested for confirmation on the network again, using the path, buyer User (I)→Antenna (A) of FIG. 3→Receiver (B)→RF/IF (C)→Baseband Processor (D)→Display Device (7) by PCS (S) or PCS (7) on DB (21): Banking/Accounting Management Service System→Switching System (15)→Control (14)→Station (12).

If buyer user (1) verifies whether the price matches by the key pad with a password, current coordinates, ID, and time of seller that have been gained in GPS through Audio/Control & Interface (F)→Function Manager (5)→Signal Hybrid/Processor (3) as FIG. 3 get marked, and are sent to Station (12)→Control (14)→Switch System→DB (21): Banking/Accounting Management Service System through Baseband Processor (D)→RF/IF (C)→Transmitter (1)→Antenna (A)→User (2) in FIG. 8→PCS (7) or PCS (5). DB (21): Banking/Accounting Management Service System revivifies all contents (price, date, location, user identification) in database. It updates database and informs the final result that it has accomplished payment to seller User (2) through PCS (5) or PCS (7) in DB (21): Banking/Accounting Management Service System→Switching System (15) Control (14)→Station (12) as shown in FIG. 8.

As technology evolves, the speed of the network becomes much faster, devices become smaller, and the law can demand that this device be attached. All process can be done real time for 24 hours a day. All procedures mentioned above can be accomplished on the network by one step that buyer User (1) inputs price.

The fact is that coordinates together with time and ID of buyer user (1) matched with coordinates of seller User (2) at the same moment of time. This is verified mutually, and it is surely a evidence that proves that User (1) appeared at the location of seller User (2) for payment. All verification information is safely stored in DB (21). If buyer User (1) and seller User (2) do a payment transaction in two different places, you can give the option to reverify at buyer User (2) on the network instead of verifying likeness between two the locations as mentioned.

Customers do not need to present anything to a seller in any case like current credit card. If this improved Cellular/PCS-GPS Hybrid system is used, a perfect payment system can be made on the network that can even verify time and location.

<5>An Instance of General I/O Interface

More applied results can be obtained if external I/O Interface (8) is used, which processed through Function Manager (5) added in this invention more than in the current simple way that gains an event through a key pad or voice recognizer. Aux. device which is External I/O Interface ought be a option because it can be separated. Select some of all of the variable I/O devices connected to a specific external I/O Interfaces (8) by Function selection of Function Manager (5) which will be mentioned later. First, an explanation on digital input device comes. When a specific function selected in the function selection menu of Function Manager (5) is activated, correspondent device address and status are gained, and coordinates and time gained in the procedure are conveyed to Baseband Processor (D) through Function Manager (5)→Signal Hybrid/Processor (3). In Signal Hybrid/Processor (3), information of those are sequentially recorded in the EEPROM (4) at the same time. Conveyed device address and status:O/I conveyed to Baseband Processor (D). gained coordinates and time, and User ID+<number to be Caller> generated in current Cellular/PCS are transmitted through RF/IF (C)→Transmitter (1)→Antenna (A), depending on the program of the Signal Hybrid/Processor (3). <Number to be Called> is conveyed to the Baseband Processor (D) through current Audio/Control & Interface (F) that has been set in the Function Manager (5).

<6>An Instance of Use for Home/Office/Out Door Security

If IR sensor device is connected to digital input, security status can be checked on real time or later through Cellular/PCS. An accurate location and time can automatically be figured when someone breaks into, no matter where the user is. Accuracy of the location depends on accuracy of GPS, and generally it can even identify specific doors or windows in an office, or specific kinds of appliances/equipments. After all signals are transmitted through Cellular/PCS antenna and are received by a specific receiver, accurate location can be monitored where an accident happened and the time it happened compared with the pre-implemented DB. Monitoring is performed by converting to the image processing technique and ACSII code comparing with DB. An advantage, this invention gives, is that improved Cellular/PCS can be used any time in any place unnecessarily being located at a specific location.

Variable history log of a specific time period can be made by saving data that is continually transmitted to DB. The DB implement can be processed as a multiple User management service system in the procedure and process it as monitoring managing per user through the internet network. In the case as above, the user number of different Cellular/PCS is directly entered in the Function Manager (5), contents of all information transmitted through Antenna (A) are converted to ASCII characters which have gone through stations's DB, and the location, time and status of something happening can be displayed on the display device of other Cellular/PCS users that have been preset as ASCII characters. The information is conveyed through Antenna (A)→Receiver (B)→RF/IF (C)→Baseband Processor (D)→Signal Hybrid/Processor (3)→Display Device (7) as shown in FIG. 3. A variety of styles of sensors can be connected such as the magnetic contact sensor, impact sensor, and etc. instead of the IR sensor mentioned above.

<7>An Instance of Use for Remote Medical Diagnosis

A device is connected to measure the heart pulse to digital input, the status of user's heart pulse can be monitored any time in any place. Especially, if the user walks or runs carrying Cellular/PCS, changes of heart pulse can be monitored depending on the speed of exercise by calculating heart rate with a location and time on real time or later on. This can be monitored on each other Cellular/PCS or on central a surveillance service center (supervisory center) respectively. If the electric current/electro-motive force converting sensor that can read an electrocardiogram is connected with input device of A/D converter, a perfect test of physical exercise can be obtained relating with heart pulse mentioned above. By connecting a variety of switches with digital input, you can monitor On/Off status. Especially, GPS can distinguish changes of electrocardiograms on uphill and downhill by outputting latitude and altitude.

<8>An Instance of Use for Home/Office Automation, etc.

If User (1) or User (2) in FIG. 8 carries Cellular/PCS, pulse sensor (connected to digital input) and electrocardiogram sensor (connected to analog input) are connected with external I/O Interface (8) in FIG. 3, signals of those reach at Station (12)→Station DB (13)→Control (14)→Switching System (15)→DB (19) passing through PCS (7) or PCS (18) in FIG. 8 through Function Manager (5)→Signal Hybrid/Processor (3)→Baseband Processor (D)→RF/IF (C)→Transmitter (I)→Antenna (A), and make it possible to create a remote medical diagnosis service system.

Cellular/PCS to Appliance/Equipment (5) as FIG. 8 and digital output (in case of light bulb) terminal are connected to external I/O Interface (8), it transmits through Audio/Control Interface (F)→Baseband Processor (D) RF/IF (C)→Transmitter (I)→Antenna (A) as shown in FIG. 3 in external User (1), Vehicle (3), or laptop computer. Movement of Appliance/Equipollent (5) is controlled through Antenna (A)→Receiver (B)→RF/IF, (C)→Baseband Processor (D)43 Signal Hybrid/Processor (3)→Function Manager (5)→External I/O Interface (8)→digital output Appliance/Equipment (light bulb, refrigerator, TV, etc.) as shown in FIG. 3. When the temperature of inside vehicle (4) or Appliance/Equipment (5) in Fig is monitored. 8, the rest of the signal process performs as mentioned above, if the temperature sensor is attached to analog input terminal of external I/O Interface (8) as shown in FIG. 3. This concept can also be applied for automatic measuring, monitoring the amount of rainfall, internal combustion, noise, and factory automation.

All processes of examples mentioned above provide advantages to remote control, to monitor and to manage using implemented user utilization DB (20) through the internet network (16) in FIG. 8.

As described, according to the present invention, it becomes possible to perceive present coordinates of a user by the GPS and to use them in local, current Cellular/PCS, or to expect to embody intellectual multipurpose functions as listed below that are impossible to embody with current technology, on network by retransmitting through current Cellular/PCS network.

1) User management (moving/surveillance) system

2) Vehicle/road network management service system

3) Toll payment management service system

4) Remote medical diagnosis service system

5) Family/office security and automation management service system

6) Security area entrance/exit monitoring management service system

7) Automatic payment management service system

8) Factory automation/control management system

9) Perfect substitute system for ID card and credit card system

10) Substitute electronic key lock system for current key lock system

It will be evident to those skilled in the art that many other modifications are possible within the spirit of the invention. Therefore, the scope of the invention should be determined by reference to the claims appended below and their equivalents.

1. An improved hybrid method of bidirectional GPS and Cellular/ICS that can use GPS signals itself by receiving it with a receiver and pass it through GPS (2) and save the data in the EEPROM (4) through the Signal Hybrid/Processor (3) to perceive the present coordinates of a user in current Cellular/PCS and use it in a local or in a network as database, or can retransmit the location signal connected with current Cellular,/PCS.

2. An hybrid method that can process coordinates signal, time, and ID with status and movement of variety external devices.

3. A hybrid method where the coordinates converted to ASCII in a database on a network lets user that address (street number, etc.) of real location with user ID (a) be displayed to user (b) through Receiver (B)→RF/IF (C)→Baseband Processor (D)43 Display Device (7) after coordinates of User (a) is transmitted through Transmitter (I)→Antenna (A) in time when user (a) calls another user (b).

4. A perfect ID card and payment method by verifying time and location data (coordinates, time, and ID) on the network using one of the methods mentioned in claim 1 or 3 to substitute the imperfect ID card system and credit card system.

5. A hybrid method that perform intellectual multipurpose function by implementing a variety of data gained by one of the methods mentioned in claim 1 of claim 4 to the database on the network.

6. An improved hybrid system of bidirectional GPS and Cellular/PCS that can use GPS signals itself by receiving it with a receiver and pass it through GPS (2) and save the data in the EEPROM (4) through the Signal Hybrid/Processor (3) to perceive the present coordinates of a user in current Cellular/PCS and use it in a local or in a network as database, or can retransmit the location signal connected with current Cellular/PCS.

7. A hybrid system that can process coordinates signal, time, and ID with status and movement of variety external devices.

8. A hybrid system where the coordinates converted to ASCII in a database on a network lets user that address (street number, etc.) of real location with user ID (a) be displayed to user (b) through Receiver (B)→RF/IF (C)43 Baseband Processor (D)→Display Device (7) after coordinates of User (a) is transmitted through Transmitter (I)→Antenna (A) in time when user (a) calls another user (b).

9. A perfect ID card and payment system by verifying time and location data (coordinates, time, and ID) on the network using one of the methods mentioned in claims 6 to 8 to substitute the imperfect ID card system and credit card system.

10. A hybrid system that perform intellectual multipurpose function by implementing a variety of data gained by one of the methods mentioned in claims 6 to 9 to the database on the network.
